(19) United States
(12) Patent Application Publication
(10) Pub. No.: US 2014/0200751 A1
(43) Pub. Date: Jul. 17, 2014

(54) FLIGHT RECORDING SYSTEM IN AN AIRCRAFT INTEGRATING THE AUDIO MANAGEMENT FUNCTION

(71) Applicant: Airbus Operations (SAS), Toulouse (FR)

(72) Inventor: Michel Colin, Colomiers (FR)

(21) Appl. No.: 14/155,841

(22) Filed: Jan. 15, 2014

(30) Foreign Application Priority Data
Jan. 15, 2013 (FR) 1350342

(51) Int. Cl. B64D 45/00

(52) U.S. Cl. CPC B64D 45/00
USPC 701/3

(57) ABSTRACT

A flight recording system with a simple, precise, reliable and low cost installation and connection architecture. This system includes a box provided with reversible fastening means onto the aircraft, said box comprising recording means for recording conversations and audio communications and audio management means for managing signals and for providing the recording means with signals originating from the audio environment of the cockpit.

### CROSS-REFERENCES TO RELATED APPLICATIONS

This application claims the benefit of the French patent application No. 1350342 filed on Jan. 15, 2013, the entire disclosures of which are incorporated herein by way of reference.

### BACKGROUND OF THE INVENTION

This invention relates to the domain of flight recording in an aircraft and more particularly recording of conversations and audio communications in the cockpit.

The development and installation of the flight recording system is important for investigations in the case of an incident or accident, thus contributing to increasing the efficiency and to promoting safety in aviation.

An aircraft is usually equipped with two recorders. The first is a conversations and messages recorder designed to record conversations and communications in the cockpit and data-link messages transmitted between the ground and the aircraft. The second is designed to record flight parameters. The two recorders are synchronized with a common time base. By regulation, the two recorders are installed in the aft part of the aircraft close to the tail because this is the part that is usually best protected after an impact with the ground or the sea.

FIG. 3 diagrammatically shows an example of a conversations and messages recording system according to prior art.

This system 101 comprises a flight recorder 107, an Audio Management Unit (AMU) 109, a Cockpit Voice Recorder Control Unit (CVRCU) 110, a Cockpit Area Mike (CAM) 112, and a Data-Link System 114.

The flight recorder or “black box” 107 comprises a Cockpit Voice Recorder (CVR) 107a designed to record conversations and communications in the cockpit and a data message recorder 107b designed to record flight data messages transmitted between the ground and the aircraft.

The data-link system 114 is installed in the avionics rack and supplies data messages to the message recorder 107b.

The CAM cockpit area mike 112 is installed in the cockpit to pick up conversations and cockpit area noise. It is connected to the cockpit voice recorder CVR 107a through the cockpit voice recorder control unit CVRCU 110. This CVR is installed in the cockpit and comprises a preamplifier 116 to amplify the signal output from the cockpit area mike CAM 112.

The audio management unit AMU 109 is installed in the avionics rack and it is destined to cover all radio and interphone communications between crew members and to send audio signals output from communications and the cockpit audio environment to the cockpit voice recorder CVR 107a.

FIG. 4 diagrammatically shows the functional architecture of a flight recorder according to prior art.

The flight recorder 107 comprises two subassemblies. The first subassembly consists of a Crash Survival Module Unit (CSMU) 111 inside which all recorded data are stored. More particularly, the crash survival module unit CSMU 111 is composed of several layers enclosing a memory 113 of the solid state type. The CSMU unit 113 is also provided with an Underwater Locator Beacon (ULB) 115 that is switched on in the case of immersion and emits an ultrasound signal to assist in positioning the aircraft.

The second subassembly consists of an electronic interface 116 that manages all received signals. It comprises four input-output interfaces 118a-118d, a Field Programmable Gate Array (FPGA) 120a, an Audio Digital Signal Processing (ADSP) means 122, an interface 124 for the CSMU unit and an interface 125a for the electrical power supply.

The first interface 118a is an input interface that receives analog audio signals on four distinct channels (channel 1-channel 4). The first, second and third channels are connected to audio communication equipment (boomsets, microphones, interphones, etc.) in the cockpit through the audio management unit AMU 109. More particularly, the first, second and third channels are connected to communication equipment of the pilot, co-pilot and the third occupant respectively. The fourth channel is connected to the cockpit area mike CAM 112 through the CVRCU 110. The first interface 118a converts analog signals received through the four channels into digital signals before sending them to the signal processing unit ADSP 122.

The second interface 118b is an output interface connected to an audio monitor of the conversation voice recorder control unit CVRCU 110. Thus, an audio signal representative of correct operation of the flight recorder may be sent to the CVRCU unit 110.

The third interface 118c is an input-output interface connected to the conversation voice recorder control unit CVRCU 110 and the cockpit area mike CAM 112.

The fourth interface 118d is an input-output interface compatible with the ARINC 429 standard and it comprises a time reference input (GMT Input), and an input (CMS Input) and an output (CMS Output) for management of failures connected to a centralized maintenance system (CMS) on the aircraft.

The field programmable gate array FPGA 120a sets up links with activation logic to automatically start up the recorder as soon as an engine is powered.

The audio signal processing means ADSP 122 manages all audio data and transfers them in digital format to the interface 124 of the CSMU unit. This unit compresses data before saving them in the solid-state memory 113 of the CSMU 111.

The electrical power supply interface 125a provides appropriate voltages to the different components of the flight recorder 116.

FIG. 5 diagrammatically shows the functional architecture of an audio management unit according to prior art.

The audio management unit AMU 109 comprises an adaptation board 132, a dual audio board 134a, 134b, an electrical power supply interface 125b and a field programmable gate array FPGA 120b.

The adaptation board 132 comprises audio input and output interfaces to interface with all analog audio signals for the pilot, co-pilot and the third occupant.

The adaptation board also comprises an interface 132a compatible with the ARINC 429 standard for failure management inputs (CMS Input) and outputs (CMS Output).

Furthermore, the adaptation board 132 comprises an interface 132b with the flight recorder comprising a time reference input (GMT Input) and three outputs through which audio signals are transmitted on three different channels specific to the pilot, the co-pilot and the third occupant. This interface 132b is adapted to mix the audio signals corresponding to each channel before sending them to the recorder 107.

The dual audio board 134a, 134b comprises first and second dedicated boards for conversations and audio communications of the pilot and the co-pilot respectively. The dual audio board 134a, 134b is destined to process digital audio data. It is also destined to manage radio communication and navigation functions and to handle management of failures and the SELCAL selective call between the ground and the aircraft.

Finally, the electrical power supply interface 125b is destined to supply appropriate voltages to the different components of the audio management unit 109.

The audio management unit 109 and the flight recorder 107 thus comprise heterogeneous interfaces (analog and digital) that require adaptation and conversion means and a large number and variety of connections.

Furthermore, as mentioned above, the audio management unit is located in the avionics rack while the flight recorder is installed in the aft part of the aircraft to satisfy the regulations. This requires many long wire connections, which increases the aircraft mass balance.

Furthermore, the architecture of the connections between the two equipment units is fairly complex and cables connecting the audio management unit to the flight recorder and carrying the different analog and digital signals must pass through the entire aircraft, passing through zones and routes sensitive to interference, which creates a number of installation problems due to segregation constraints.

Furthermore, aeronautic needs are increasingly dictated by particularly severe reliability and redundancy constraints. Thus, the intended regulations require that two flight recorders should be installed in different parts of the aircraft, consequently once again increasing the number of wire connections.

Consequently, the purpose of this invention is to overcome the disadvantages mentioned above by disclosing a recording system with a simple, precise, reliable and low cost installation and connection architecture.

### SUMMARY OF THE INVENTION

This invention relates to a flight recording system in an aircraft comprising recording means to record conversations and audio communications, and audio management means destined to provide the recording means with signals output from the audio environment in the cockpit, the system comprising a box containing said recording means and said management means.

This reduces the weight and simplifies the connection architecture by reducing wiring while minimizing interference, given that the recording means and management means are contained in the same box.

Advantageously, said recording means and said management means are combined together in said box and their common functions are factorized. This can simplify and minimize the number of components and connections, facilitate integration and reduce the weight and costs.

The invention also relates to an aircraft comprising a first box with the above characteristics installed in the avionics rack and a second box with the above characteristics installed in the aft part of the aircraft.

### BRIEF DESCRIPTION OF THE DRAWINGS

Other characteristics and advantages of the invention will become clear after reading the preferred embodiments of the invention with reference to the appended figures among which:

FIG. 1 very diagrammatically shows a flight recording system according to one embodiment of the invention;

FIG. 2 very diagrammatically shows the functional architecture of the management and recording box according to a preferred embodiment of the invention;

FIG. 3 diagrammatically shows an example of a recording system according to prior art;

FIG. 4 diagrammatically shows the functional architecture of a flight recorder according to prior art, and

FIG. 5 diagrammatically shows the functional architecture of an audio management unit according to prior art.

### DETAILED DESCRIPTION OF THE PREFERRED EMBODIMENTS

The concept of the invention comprises of integrating the audio management function into the electronic interface of the flight recorder.

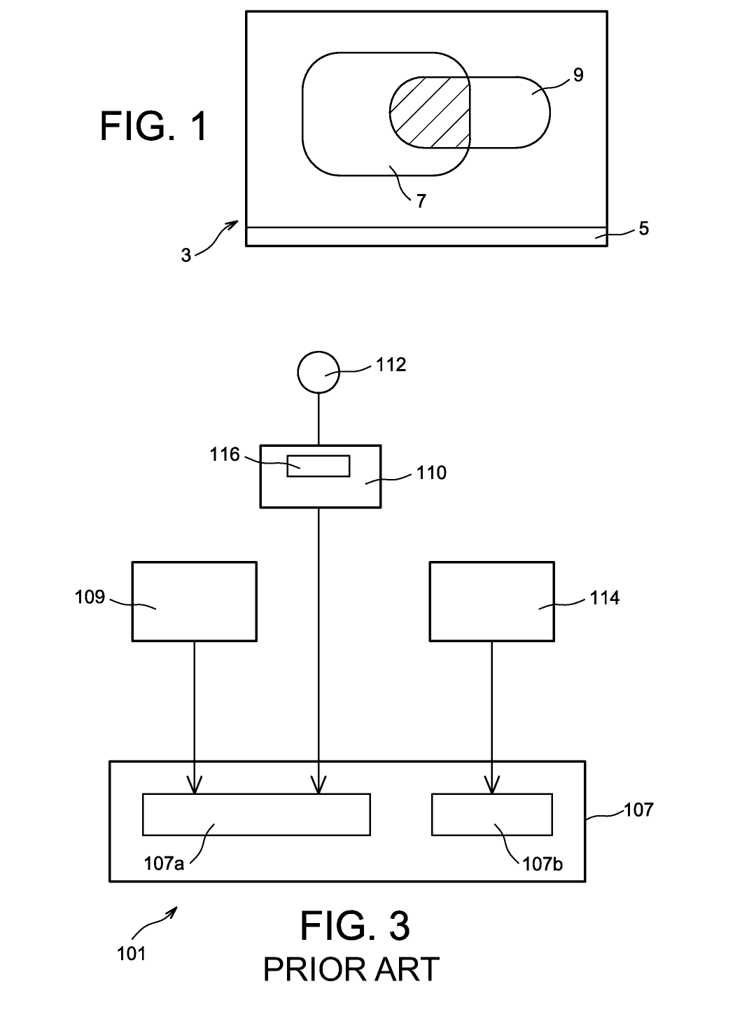

FIG. 1 very diagrammatically shows a flight recording system according to one embodiment of the invention.

According to the invention, the recording system is composed of a management and recording box 3 comprising recording means 7 and audio management means 9. Thus, the recording means 7 and management means 9 are integrated into the same box 3.

The recording means 7 is destined to record conversations, noise and audio communications in the cockpit. The audio management means 9 is destined to manage signals and provide the recording means 7 with signals output from the audio environment in the cockpit.

More particularly, the recording means 7 and the audio management means 9 are merged together by factorizing (i.e., put in common) their common functions (cross-hatched part) to form a single unit materialized by the management and recording box 3. Thus, same electronic means may be used for audio management and recording functions. Advantageously, all audio signals received or sent by the box 7 pass through digital connections.

Furthermore, the embodiment in FIG. 1 shows that the management and recording box 3 is provided with reversible attachment means 5 on the aircraft.

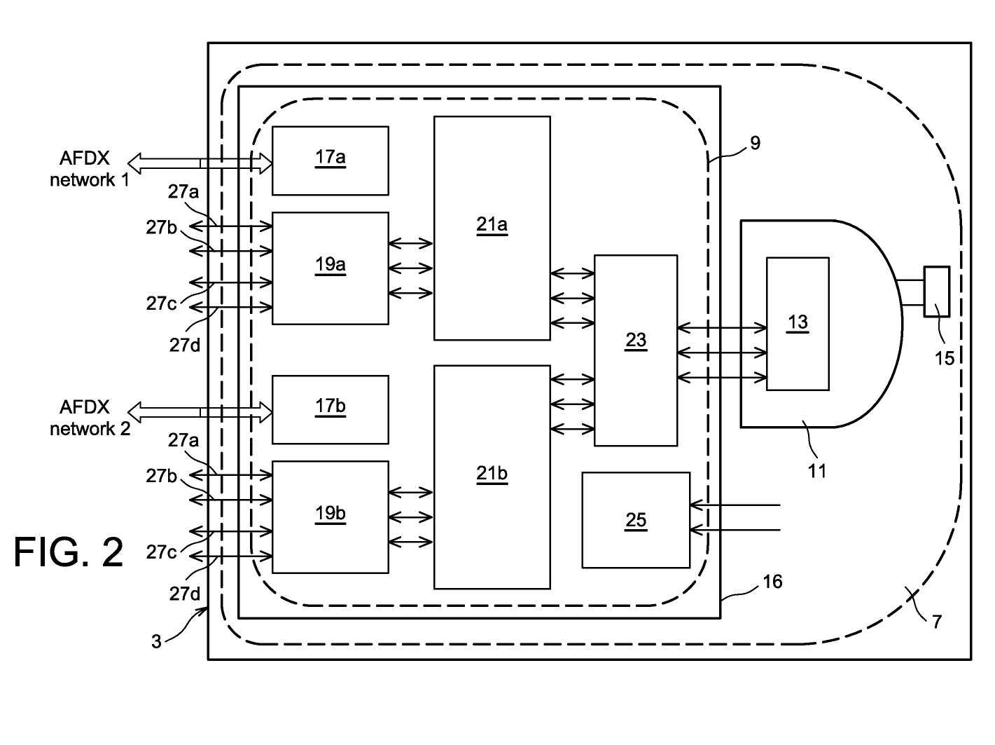

FIG. 2 diagrammatically shows the functional architecture of the management and recording box, according to a preferred embodiment of the invention.

The box 3 comprises two parts. The first part still consists of a CSMU unit 11 enclosing storage (or memory) means 13, for example a solid state type memory, for storing recorded data. Thus the memory 13 is protected by a casing resistant to shocks, fire and deep immersion. The CSMU unit 11 is also provided with a ULB beacon 15.

The second part of the box corresponds to the electronic interface 16 that controls and manages the signals and records the different data in the memory 13. This second part comprises first and second end systems 17a, 17b, first and second digital sound links 19a, 19b, first and second digital signal processing means 21a, 21b, a calculation means 23 and electrical power supply means 25.

The first and second end systems 17a, 17b are adapted to be connected to first and second communication networks respectively (AFDX network 1, AFDX network 2) of the aircraft.

It will be noted that the aircraft communication system allows digital equipment to send and/or receive data through AFDX (Avionics Full Duplex Switched Ethernet) type networks.

It is reminded that the AFDX network developed for aeronautical needs is based on a switched Ethernet network. Furthermore, the AFDX network uses the concept of a virtual link defined as a path oriented through the network, derived from a source terminal and serving one addressee or a plurality of addressees.

The box 3 can then simultaneously send and receive frames through an end system 17a, 17b, on virtual links on the same physical link. The AFDX network is also deterministic in the sense that virtual links have guaranteed characteristics in terms of latency limit, physical flow segregation, passband and flow. Each virtual link has a reserved path from end to end through the network for this purpose. Data are sent in the form of IP packets encapsulated in Ethernet frames.

All radio communication and navigation signals and selective calls SELCAL between the ground and the aircraft are thus managed in complete safety through AFDX networks through the first and second end systems 17a, 17b. Similarly, signals related to the time reference, failure management and activation logic pass through the first and second end systems 17a, 17b.

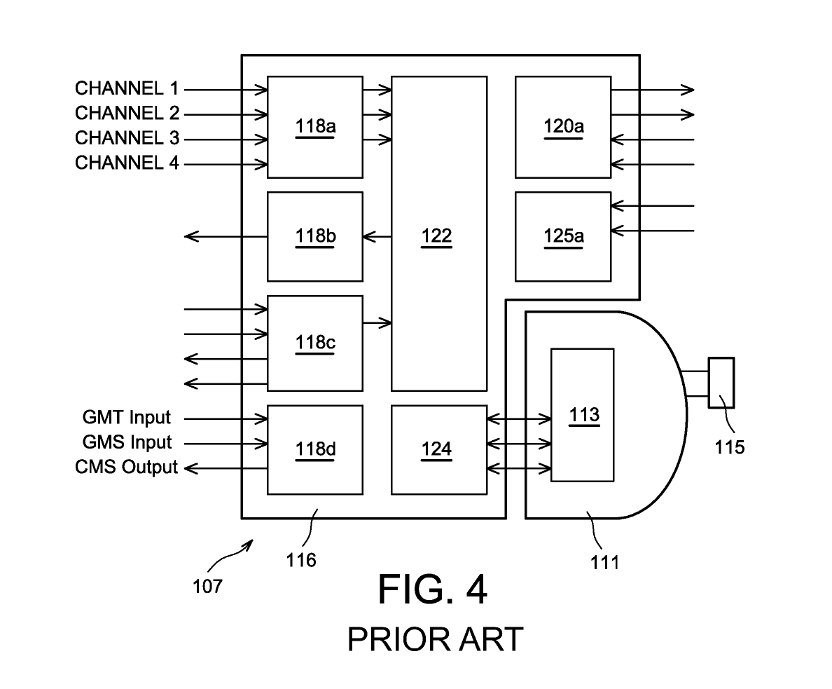

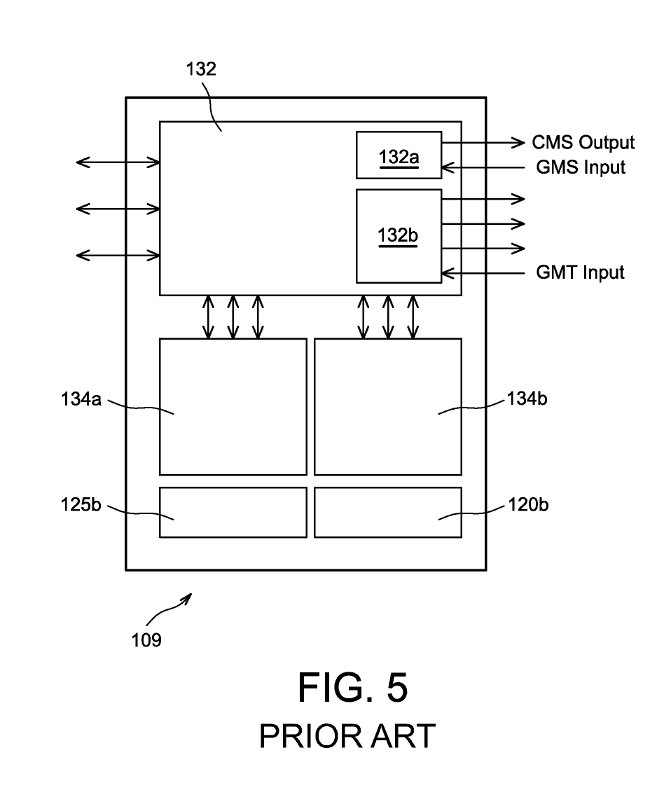

The first and second end systems 17a, 17b thus replace several interfaces of the audio management unit and the flight recorder according to prior art such as ARINC 429 interfaces and field programmable gate arrays FPGA (see FIGS. 4 and 5 in prior art).

The first and second digital sound links 19a, 19b are for example digital audio serial links. Each of the digital sound links 19a, 19b is adapted to be connected to a set of audio channels 27a-27d comprising a first channel 27a for the pilot, a second channel 27b for the co-pilot, a third channel 27c for the third occupant of the cockpit, and a fourth channel 27d for the audio environment (engine noise, alarms, actuation of commands, etc.) in the cockpit. According to the invention, boomsets, mikes, interphones, area mike and other sound units in the cockpit are digital units. Thus, there are no longer any analog connections or interfaces, which reduces the number of connections and further simplifies the architecture in comparison with the prior art. It will be noted that the cockpit area mike CAM is now directly connected through the fourth channel 27d to the management and recording box 3.

The first and second digital signal processing means 21a, 21b are connected to the first and second end systems 17a, 17b respectively, and to the first and second links 19a, 19b. All data and all signals passing through the end systems 17a, 17b and the digital sound links 19a, 19b are managed and processed by the processing means 21a, 21b according to their assignment. Thus, without using any analog/digital conversion, the processing means 21a, 21b perform management unit processing functions (FIG. 4 in prior art) as well as flight recorder functions (FIG. 3 in prior art).

The digital signal processing means 21a, 21b are configured to manage all radio communication and radio navigation functions through AFDX networks via the end systems 17a, 17b. This helps to manage communications between crew members, between the cockpit and the cabin, between the cockpit and the ground, and passenger announcements, etc. Failure management and the activation logic are also managed by the digital signal processing means 21a, 21b through the AFDX networks.

Similarly, the digital signal processing means 21a, 21b are configured to manage and mix audio signals belonging to a single channel before sending them to the calculation means 23.

Advantageously, the first processing means 21 a are dedicated to pilot conversations and communications, while the second processing means 21b are dedicated to co-pilot conversations and communications. Thus, the duality of the processing means 21a, 21b and the digital sound links 19a, 19b maintains segregation between the pilot's channel and the co-pilot's channel.

The calculation means 23 provides the interface between the memory 13 and the first and second processing means 21a, 21b. The calculation means 23 performs the same functions as the interface of the CSMU unit according to prior art (see FIG. 4) and in particular, data compression for data to be recorded before the data are sent to be recorded in the memory 13.

The first and second processing means 21a, 21b and the calculation means 23 are also adapted to manage and record data messages received from the first and second AFDX networks through the first and second end systems 17a, 17b, in the memory 13. Thus, voice data and data messages are recorded in the same box 3.

Finally, the electrical power supply means 25 will provide appropriate voltages to the different means or components of the box 3. The electrical power supply means 25 are thus common to audio management and recording functions.

It will be noted that the second part of the box 3 (i.e., the electronic interface 16) performs all audio management functions and then corresponds to the audio management means 9. Furthermore, both of the two parts correspond to the recording means 7. In other words, with this preferred embodiment of the invention, the audio management means 9 are entirely included in the recording means 7.

Thus, audio management and recording functions according to the invention are made entirely digitally inside a single box 3. This eliminates tens of meters of wiring, minimizes interference problems, simplifies the connection architecture and eliminates equipment weighing several kilograms.

In particular, all audio communication and recording signals are digital and are entirely managed through the end systems 17a, 17b and digital sound links 19a, 19b. Thus, all adaptation interfaces and all analog-digital or digital-analog conversions according to the prior art are eliminated.

Furthermore, all signals and data messages are managed through AFDX networks. Thus, ARINC 429 interfaces and logical interfaces are no longer necessary.

Advantageously, according to a first embodiment and installation method, the box 3 is compatible with the ARINC 600 standard so that it can thus be directly installed in the avionics rack.

According to a second embodiment and installation method, the box 3 is compatible with the ARINC 404 standard, for example with the ½ ATR long format. This means that the box can be installed close to the avionics rack.

Advantageously, a first management and recording box 3 is installed close or inside the avionics rack and a second management and recording box 3 is installed in the aft part of the aircraft.

As is apparent from the foregoing specification, the invention is susceptible of being embodied with various alterations and modifications which may differ particularly from those that have been described in the preceding specification and description. It should be understood that I wish to embody within the scope of the patent warranted hereon all such modifications as reasonably and properly come within the scope of my contribution to the art.

1. A flight recording system in an aircraft comprising:
recording means destined to record conversations and audio communications,
audio management means destined to provide recording means with signals output from the audio environment in the cockpit, and
a box containing said recording means and said management means.

2. The system according to claim 1, wherein said recording means and said management means are combined together to form a single unit materialized by said box.

3. The system according to claim 1, wherein said box comprises:
a memory to store recorded data, said memory being protected by a casing) resistant to shocks, fire and immersion, first and second end systems adapted to be connected to first and second aircraft networks respectively,
first and second digital sound links, each of said links being adapted to be connected to a set of audio channels comprising a first channel for the pilot, a second channel for the co-pilot, a third channel for the third occupant, and a fourth channel for the audio environment in the cockpit,
first and second digital signal processing means connected to the first and second end systems respectively and to the first and second digital sound links, said first and second processing means being configured to manage and process data and signals passing through the first and second end means and through the first and second digital sound links,
a calculation means providing the interface between said memory and said first and second processing means, said calculation means being configured to compress data to be recorded and to adapt corresponding signals before recording them in said memory, and
electrical power supply means designed to provide appropriate voltages to the different means in the box.

4. The system according to claim 3, wherein the first processing means are dedicated to pilot conversations and communications, while the second processing means are dedicated to co-pilot conversations and communications.

5. The system according to claim 3, wherein the first and second processing means are adapted to manage radio communication and radio navigation functions.

6. The system according to claim 3, wherein the first and second processing means and the calculation means are adapted to manage and record data messages received from the first and second networks through the first and second end systems in the memory.

7. The system according to claim 1, wherein said box is provided with reversible attachment means on the aircraft.

8. The system according to claim 1, wherein the box is compatible with the ARINC 600 standard.

9. The system according to claim 1, wherein the box is compatible with the ARINC 404 standard.

10. An aircraft comprising a recording system according to claim 1, wherein a first box containing said recording means and said management means is installed in an avionics rack and a second box containing said recording means and said management means is installed in an aft part of the aircraft.
